(19) United States
(12) Patent Application Publication
(10) Pub. No.: US 2002/0100346 A1
(43) Pub. Date: Aug. 1, 2002

(54) Self-locking fastener system and process

(76) Inventor: Lloyd S. Binns, Harbor City, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/016,809

(22) Filed: Nov. 30, 2001

Related U.S. Application Data
(60) Provisional application No. 60/255,053, filed on Dec. 12, 2000.

(51) Int. Cl. B25B 13/06

(52) U.S. Cl. 81/121.1

(57) ABSTRACT

A left hand helical flute crosses right hand threads on a pin inserted into a hole in materials to be joined. A nut smoothly cooperating with the pin threads has a top portion that has three convex, equilateral sides meeting at apices capping their deformable crests. To work the nut, three irregular faces of six within a socket first apply tangential torque at locations near the nut apices. Tightening develops resistance and as the rotating nut slows down, the socket's irregular faces displace nut crest material circumferentially. Torque rises and demand reaches maximum when the socket faces coincide with the nut apices. Thereafter, the nut stops rotating, and the working surfaces move toward disengagement. Torque dips, but rises again when three flat faces of the socket take a second pass at residual nut crest material. Now to deliver radial torque, they crush some underlying nut thread portions that straddle the pin flutes and lock the threads to defeat vibrational forces tending to unwind the nut in service application.

### CROSS-REFERENCE TO RELATED APPLICATIONS

This application takes priority from Provisional Patent Application Serial No. 60/255,053 filed Dec. 12, 2000.

### BACKGROUND OF THE INVENTION

1. Field of the Invention

This invention relates generally to the field of mechanical self-locking fastener systems and more specifically to fluted pins and swagable nuts that lock together upon tightening to a predetermined load by means of a uniquely shaped socket tool.

2. Prior Art

The invention here relates fundamentally to the system described by Wing in U.S. Pat. No. 3,390,906 showing a socket, a pin having a head, a shank with a threaded portion surrounding an end recess, and a mating collar. A circular groove on the collar defines a frangible connective neck of material accenting a distinction between a forward barrel portion that is cylindrical and a torqueable and expendable rearward portion that is hexagon shaped.

A different invention by Stencel shows, in U.S. Pat. No. 4,260,005 a modified pin with axial flutes interrupting the last few threads. A dedicated nut also features multiple barrel portions: a larger forward cylindrical portion and a smaller rearward cylindrical portion with longitudinal lobes equally spaced on its circumference. When the Stencel pin is inserted into a hole drilled into materials to be joined and the nut is threaded onto the pin, a rotational socket that has three flat faces and a fixed internal hexagon key, engages the pin recess and the nut lobes. Allowed to rotate, the socket first tightens the nut and thereafter swages into the axial pin flutes the longitudinal nut lobes that critically index into and out of mutual alignment. Optimum alignment of lobes and flutes at the instant of swaging is thus uncertain and locking quality varies from one installation to another. Intended for high volume use on aircraft assembly lines, an acceptable fastener, in general, must be lightweight, installation quick and functionally self-inspecting. The nut must be free-running on the pin threads, and the fastened joint must meet the specified range of grip variation, pre-load, shear, tensile, fatigue, resistance to vibration, locking integrity and corrosion resistance. While systems of this type work well in metal structures they fail requirements for use in synthetic substances, such as graphite/epoxy composite materials that are lighter than aluminum and stronger than steel. Unfortunately, those synthetic materials are brittle and require a loose fit between fastener and hole. Lack of hole filling encourages moisture seepage and fuel leaks that are preventable if fastener and hole are pre-coated with a sealant. Regrettably, this sealant also acts as a lubricant under the fastener head, reduces friction and encourages the fastener to rotate during installation. Unable to restrain the fastener, the flimsy hex key fails by fracturing, if brittle, or by twisting like a corkscrew, if ductile.

This undesirable condition occurs unexpectedly. Little, if any, gradually increasing demand for restraint is indicated, but at maximum torque sudden hex key failure occurs to frustrate a critical transition from the tightening phase to the locking phase of installation. Fault for this frustration comes from a well-known elastic property of metals. At maximum torque the elastic nut wall yields radially inwards, sufficient for the threaded fastener components to bind. The rotating nut then captivates the stationary pin and causes the hex key to fracture or to twist and to render impossible plastic deformation of the nut lobes. This subtle phenomenon goes undetected when the fastener is installed in metallic structures because friction between fastener and metal structure provides a latent first resistance to rotation when the nut grabs the pin. FIG. 10 discussed later in this disclosure gives a pictographic view of the problem for the

0.250 inch fastener and its hex key that can provide only a maximum of about 40 lb.-inches of counter-torque before exhibiting brittle failure.

Insufficient diagnosis of the problem with the Stencel system led to another invented system that unwittingly intensifies the disadvantage. Wallace in his invention of U.S. Pat. No. 4,601,623 consequently shows an elliptic nut with major and minor axes to define a geometric figure appearing as a flattened circle that bulges toward both ends of the major axis. An associated tool socket with the same geometry proved unreliable, sometimes twisting off the nut top barrel portion. Improvement came at the expense of simplicity wherein U.S. Pat. No. 5,145,300 describes a two-tiered elliptical nut with a substantial middle barrel portion to carry the greater torque of tightening and a smaller elliptical end barrel portion to deform with less torque.

This stack-up of nut barrel portions also complicates the socket which must now have a stepped cavity as shown in U.S. Pat. No. 5,692,419. The twin cavity socket is configured with sets of parallel-faced, diametrically opposed surfaces that contact the nut, but the force vector acting along the central diameter line connecting those parallel surfaces tends to strangle the nut. The collapsive force distorts the hoop characteristics of the nut to urge the nut threads upon the pin threads prematurely. Such a relation between the socket tool and the nut is certainly less advantageous than the expectations from the Stencel system that allows tool pressure contact along three equally spaced longitudinal lobes on the nut barrel. Thus, the elusive remedy for hex key over-strain is still the weakness of prior art fasteners of this type.

A further manufacturing complication of the socket cavity is the inclusion of Oblique driving and swaging ridges that establish a non-axial direction for the movement of nut material. To keep the socket affixed to the nut throughout the installation cycle, said oblique socket ridges transform the nut lobes that were manufactured with an axial orientation, thereafter to give them a slanted direction. As a consequence of the nut lobes, under reconstruction, cooperate with the oblique socket faces to prevent tool cam-off that is a natural reaction to the severe force of installation. Effective as they are however, said oblique socket faces are expensive to manufacture and are necessary features of both the driving and the swaging faces of the socket.

Therefore, the need still exists to develop a self-locking fastener system that:

(1) avoids the problem of transitional radial, elastic yielding of nut material so that the nut will not grab the pin to over-burden the hex key;

(2) simplifies the nut configuration by reducing the number of nut barrel portions from three to two;

(3) stabilizes the nut and socket relation for triple contact instead of the diametrically opposed double contact relation with an elliptical nut;

(4) reduces from two to one the number of internal socket cavities of the tool;

(5) avoids the situation wherein the longitudinal nut lobes play hide-and-seek with the pin flutes; and

(6) eliminates the manufacturing difficulty associated with “oblique driving and swaging” ridges on the cavity faces of the socket tool.

### SUMMARY OF THE INVENTION

General Objects

Two general objects of this invention are: (1) to simplify the manufacturing processes so that the pin, the nut and the installation socket tool can be mass-produced economically; and (2) to do the installation in two distinct but progressive stages while using a socket tool with only a single cavity. Neither of the two prior art swagable systems is economical to manufacture and the Stencel pin seems prohibitively expensive since the five flutes have to be precisely ground, one at a time.

Specific Objects

A first specific object for mass-producing the pin is to form the flutes by thread rolling rather than by grinding. The flutes will consequently have a helical form and will not play peek-a-boo with the rotating nut lobes (see FIG. 1). Obviously, the ribbed lobes of the Stencel nut will not function with helical pin flutes and must be modified. Prior design calls for the entire lobe to be radially displaced all at once. The new requirement modifies the flow process so that selective portions of the lobe may be deformed either tangentially or radially per requirements of the underlying, fluted thread form of the pin.

Therefore, a second specific object is for the nut barrel to contain flexible, lateral elevations that can be modified during installation by the tool so that material will flow either tangentially or radially. Such elevations are limited to three, and are defined by surfaces meeting at crested apices on a barrel whose planar sides are curved and are of equal length (see FIG. 3B). Such lobes appear as buttresses that support triple contact with the cooperating faces of the installation socket, not possible with an elliptical nut.

A third specific object is to provide a nut with just two barrel portions instead of the existing three that define both variations of prior art swagable nuts that seldom can be manufactured to meet their delivery schedule. This new nut has an enlarged forward barrel portion that is cylindrical and a smaller rearward barrel portion that is basically triangular (see FIG. 3B) with a circular groove marking the distinction between forward and rearward portions. Unlike the Wing collar, however, this non-frangible groove discourages the possibility of foreign object damage to airframe as experienced when the torqued-off portion of the Wing nut is ejected from the installation tool.

A fourth specific object is to set the fastener by engaging to the torqueable nut barrel the single cavity of a tool socket that has an array of driving surfaces and swaging flats working in tandem fashion, simultaneously on each nut crest to accomplish installation in two distinct and separate phases: such working surfaces being offset from each other so that no two surfaces that work together are parallel or work together along a diametric line (see FIGS. 8 and 4).

A fifth specific object is to torque the nut, when it resists, by causing the driving surfaces of the socket to burrow into a portion of each nut crest to induce tangential yielding and build dynamic ribs that enhance torque delivery (see FIG. 5), each driving surface distinguished by an interruptive axial ridge line that results when a flat surface suddenly changes direction so that the inflexion line obtained is parallel to the nut axis.

A sixth specific objective is to provide a means to keep the tool from coming off when the nut becomes increasingly resistant to torque, such means appearing as a small backward taper on the rearward portion of the three shaped surfaces of the socket so as to work the rearmost tip of the nut into the form of an enlarging cone, such cone to be erased thereafter by the swaging action of the three smooth socket faces that have no taper.

A seventh specific object is to swage deform selective portions of the nut threads by radial compression so that they permanently collapse and bunch together into the winding path of the pin flute, thereby negating their ability further to slide. It can be seen in FIG. 3A, that not every nut thread in a given axial plane can be compressed and flattened because some are contained by pin threads. It is therefore clear that all material subtended by nut threads must have the option to flow radially or tangentially.

A side benefit from the helical pin flute design is that it can serve as a hydraulic pressure vent for any sealant entrapped within the pin threads. These and other objects will be apparent with a description of the working details that follow.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an elevational view of the helical fluted and threadable end of a fastener in accordance with a preferred embodiment of the invention;

FIG. 2 is a view similar to FIG. 1 but showing the addition of threads;

FIG. 3A is a partially cross-sectioned view of the installed fastener, the nut and the socket of the invention;

FIG. 3B is a side view of the nut with partial cross-sectioning;

FIG. 3C is a partial top view of the nut;

FIGS. 4-7 are sequential views showing the engagement of the socket tool with the nut during installation;

FIG. 8A is a perspective view of the socket tool of the preferred embodiment;

FIG. 8B is a front view of the socket elements;

FIG. 8C is a cut-away internal view of the back taper on the shaped faces of the socket;

FIG. 9, comprising FIGS. 9A and 9B, show side and end views, respectively, of an alternative fastener embodiment; and

FIG. 10 is a comparative graph of ideal torque versus rotation for the invention and for a prior art system.

### DETAILED DESCRIPTION OF PREFERRED EMBODIMENTS

The present invention comprises a threaded fastener, a locking nut, and an installation socket tool along with a process, which together define a unique fastener system.

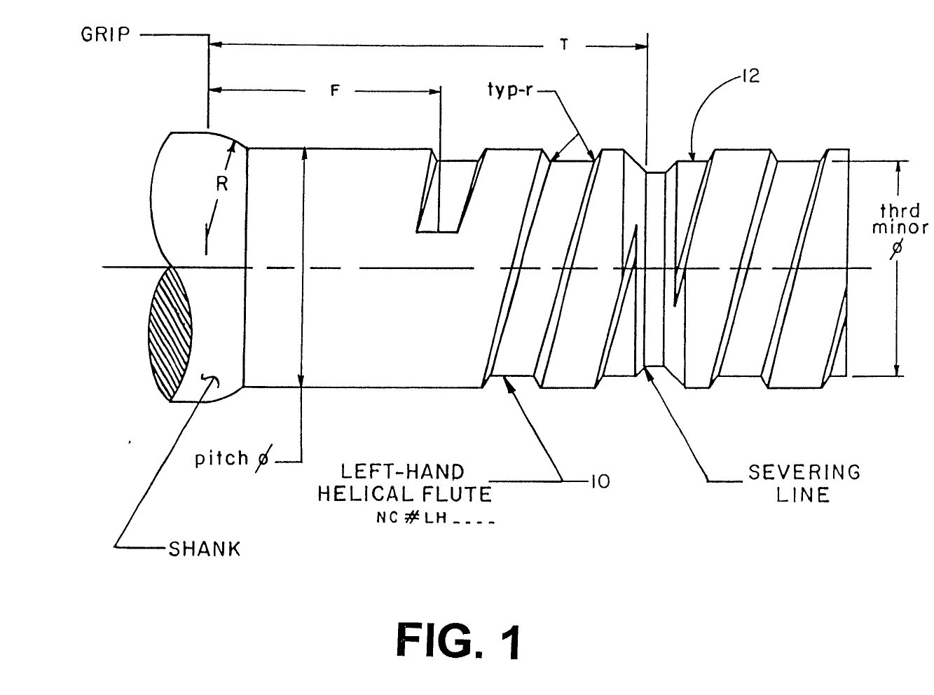

FIG. 1 shows a reverse helical pin flute design 10 that unlike the case with axial fluted pins, should cause all of the nut threads to fail when subjected to a critical force, thus raising the tension strength of the nut. Two turns of this helical flute are sufficient to assure a universal lock when the mating nut is swaged. Rolling may be an easy way to form the helical flute but a centerless grinding operation would have to be added to remove undesirable burrs from the pin before thread rolling. The pitch of the flute should be coarser than that of the pin thread.

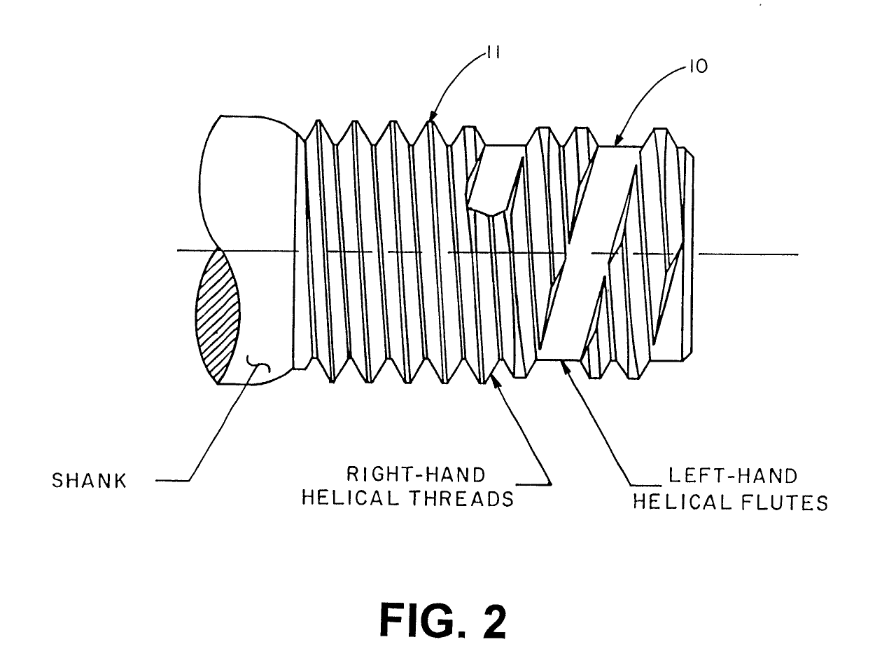

FIG. 2 shows both threads 11 and helical flute 10 on the pin. Flute 10 and threads 11 share a common minor diameter 12, but their pitches are contrary, so that a left-hand flute crosses over right-hand threads. Grinding this flute after thread rolling may be preferred because a pre-rolled flute would not remain clean, but would encourage rollout burrs when the threads are subsequently rolled.

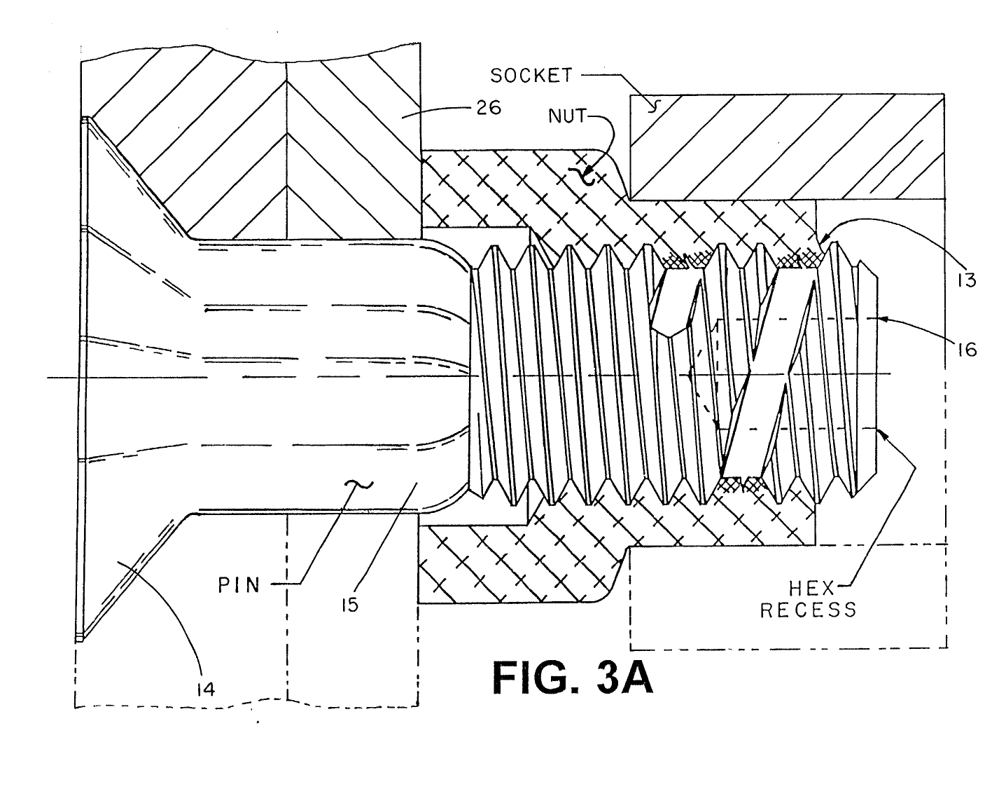

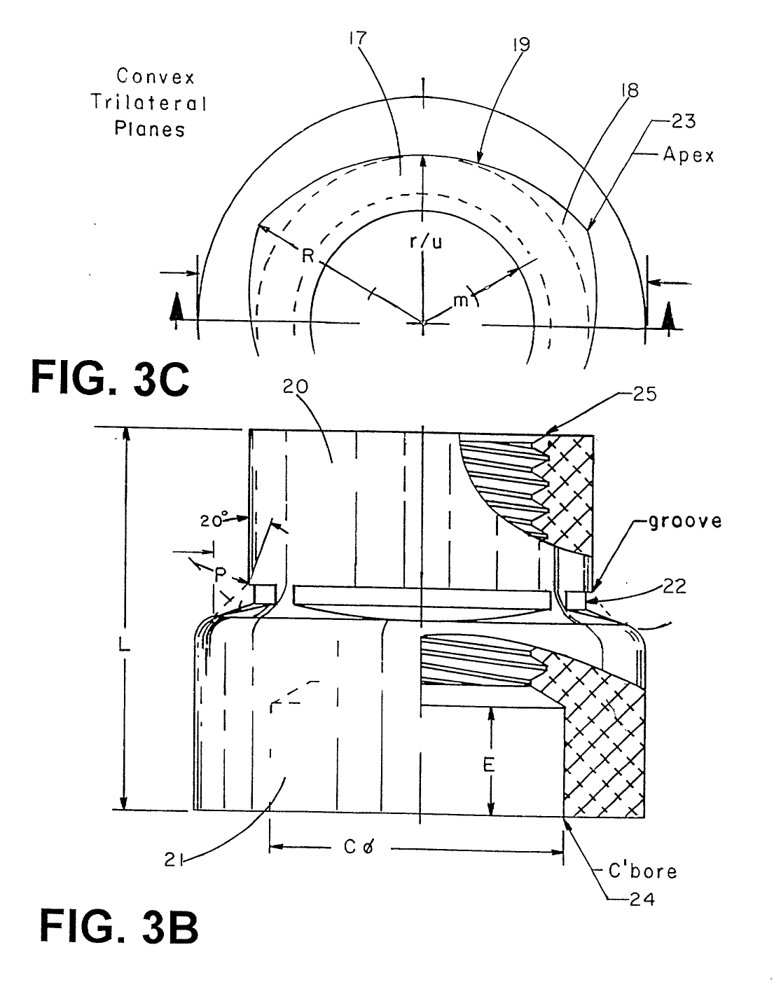

FIG. 3A is a view of the installed nut that shows the effect of radial compression of the nut wall crushing of the underlying nut thread portions 13 straddling the pin flutes 10. This particular width of the helical flute allows two nut threads to collapse and bunch together, thus rendering pin and nut threads no longer confluent and unable to slide. Above the axis (as shown) four of the total of five resident nut threads are crushed, and below the axis, two threads collapse. It is not expected that nut thread portions in the three intercrest zones 17 will collapse, because those zones function to receive material. On the other hand, the material rich regions of the nut crests 18 are forced by the tool socket to yield their store of material, either by radial collapse or by tangential flow. This arrangement should allow all of the nut threads to be sheared out when the nut fails in tension, and the end result will be an increase of joint tension load.

The fastener, or pin, has a head 14, a smooth shank 15, and on the end a shaped recess 16 for a restraining key preferably hexagon. Helical threads 11 occupy the cylindrical surface of the end portion and spiraling flutes 10, or grooves, interrupt the last few threads (FIG. 2). Threads and flutes advance in opposite directions, such that right hand threads are interrupted by left hand grooves and vice versa. The pitch of the flutes is coarser than that of the threads; for example, if the thread pitch is 0.250-28 threads per inch, the flutes can be 0.250-20 or fewer. Flutes 10 have a shallow depth coinciding with the minor diameter 12 of the threads and may be of single or multiple lead design.

FIGS. 3B and 3C provide greater detail of the nut. The view of FIG. 3C outlines the convex trilateral planes 19 that form the driving barrel 20 that sits on top of the larger, forward, cylindrical portion 21 of the nut. A shallow groove 22 separates the two nut portions, but there is no frangible neck to facilitate twist-off. The purpose of the groove is to allow for a cleanly finished border after the triangular barrel portion is swaged to roundness.

The nut (FIG. 3B) has two contiguous body portions; a larger, cylindrical forward portion 21 and a smaller, equilateral rearward portion 20 whose three sides 19 are planar and arcuate so that they coincide at apices 23 on crests where convex surfaces meet. A circular groove 22 that does not produce a frangible neck of material between the two nut body portions provides a uniform margin so that swaged material will have a clean border. Concentric bores define the inside of the nut, with a partial counterbore 24 in the forward end and a threaded bore 25 rearward thereof. Freely engaging the threads of a matching pin, inserted into a hole drilled into workpieces 26, the nut meets resistance when it contacts the workpieces 26.

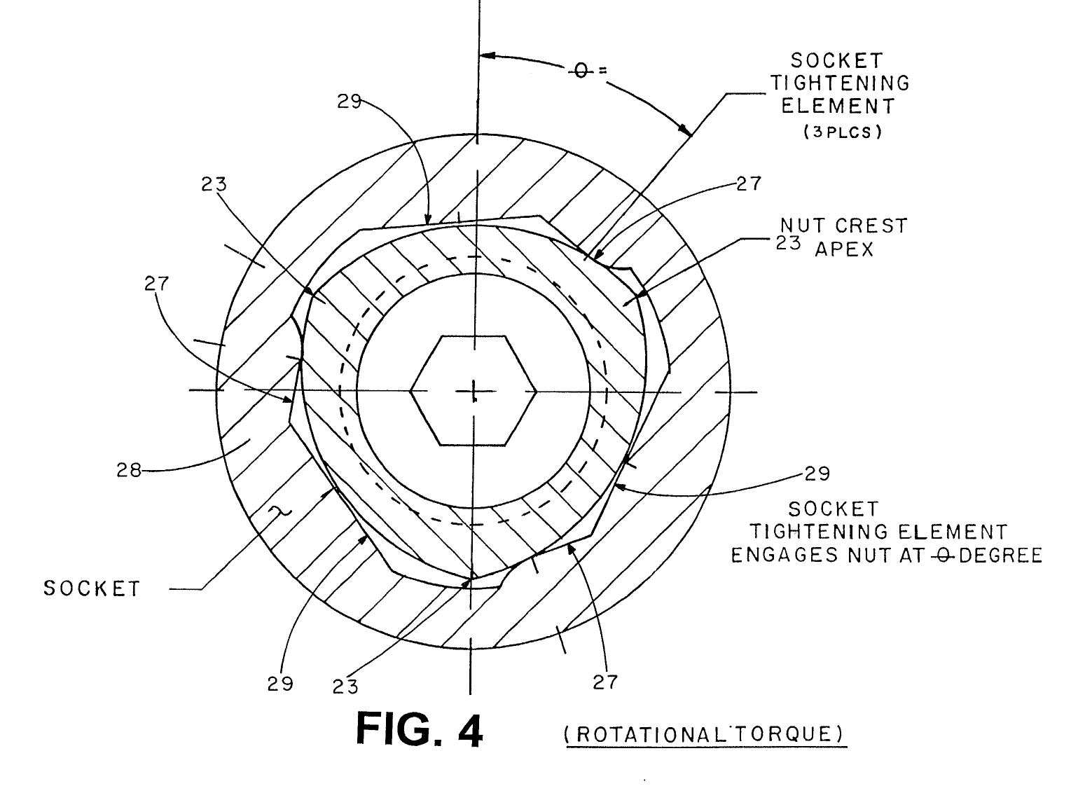

FIG. 4 shows the first step in the installation process. The three tightening elements 27 of the socket 28 contact nut crest material adjacent the apices 23 to transmit rotational torque. We assume that the joint is sufficiently tightened in this view so that further tightening will cause the contoured face of the tightening element to start to burrow into the nut material. Observe that the three flat faces 29 of the tool 28 are not in contact with the nut surface and that they are separated from the tightening element 27 by an angle greater than Ø degrees.

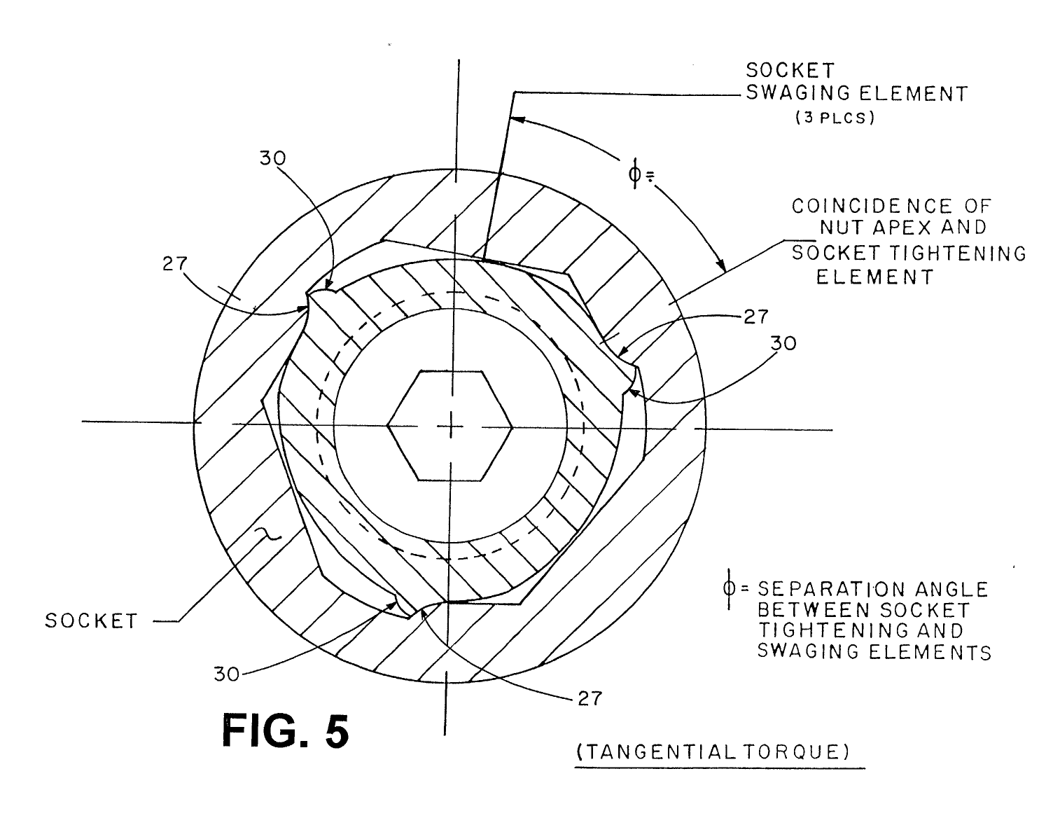

FIG. 5 continues the tightening phase of the fastener, but shows how the shaped face of each tightening element 27 of the socket 28 digs into the nut crest 23 to push up a rib of material 30, elevating the tangential component of torque and encouraging the increasingly reluctant nut to continue to rotate. Since each tightening element 27, at this stage, is rounding off the apex 23 of the nut lobe, system torque is at maximum. Concurrently, the flat swaging face 28 of the socket is almost ready to contact residual nut material unworked by the tightening element 27. This relation between the two cooperative faces of the socket assures that rotational torque will plunge, so that the nut can come to rest before the swaging force becomes dominant. System torque may even rise again above previous levels, but as the second torque vector will be more radial than tangential, the nut will not resume rotation and the hex key will sense no new demand for restraint.

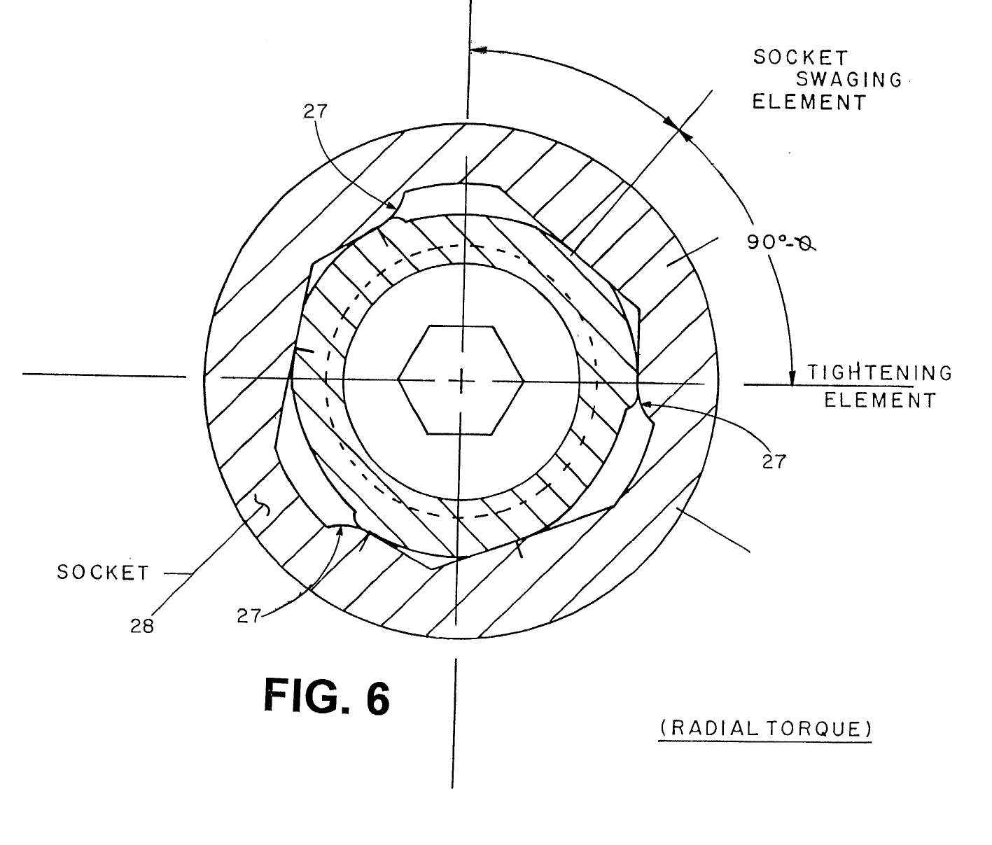

FIG. 6 shows that each tightening element 27 of the socket 28 is almost idle because it has spread all of the material it removed from the fore side of the nut crest to the aft side. Concurrently, the flat face 29 of the socket 28 is at the location formerly occupied by the nut apex and is exerting its heaviest radial crushing of the nut wall. At this stage, the underlying nut threads experience their greatest compression to collapse and to spread themselves laterally into the pinflute 13 (FIG. 3B). The advantage of this installation sequence is that it allows a delay between tightening and locking, for a NEUTRAL shift from tangential to radial torque thereby circumventing the yielding problem of the prior art.

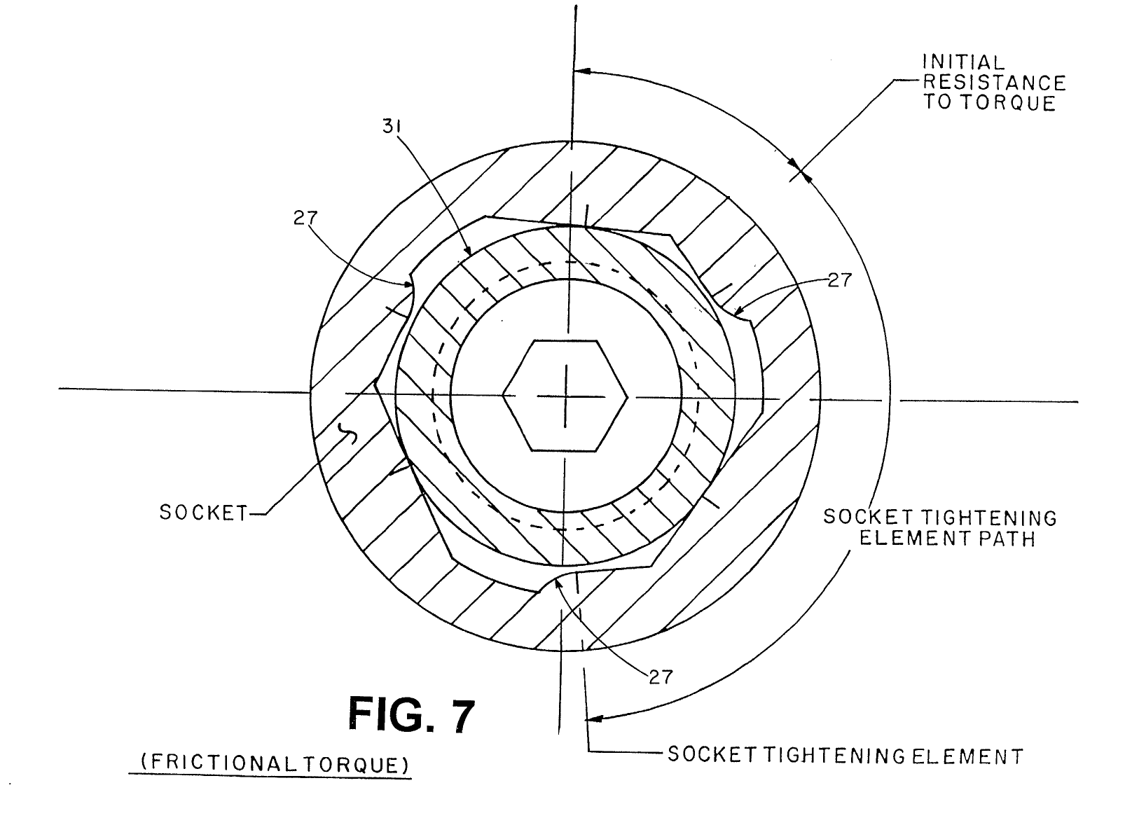

FIG. 7 shows a nut barrel 31 that is no longer triangular but cylindrical. The installation process is successful, and the tightening elements 27 are now idle while the swaging faces impart only frictional torque on the nut. To indicate the work that has been done on the nut, each of the socket tightening elements 27 will have rotated through an angle of about 135 degrees relative to the nut surface.

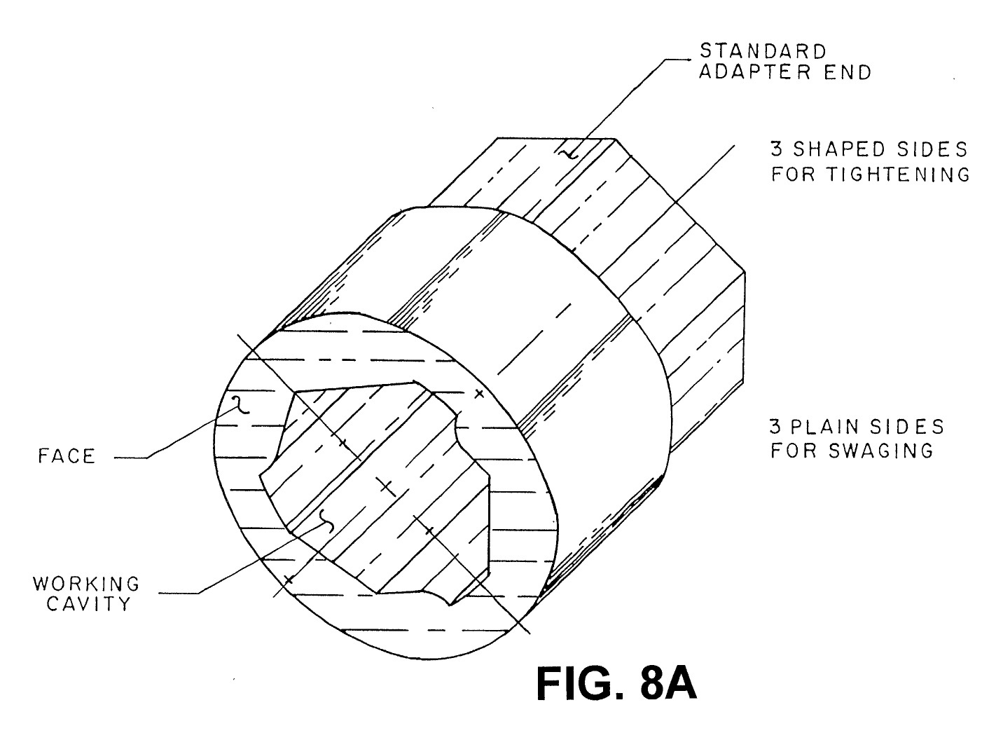

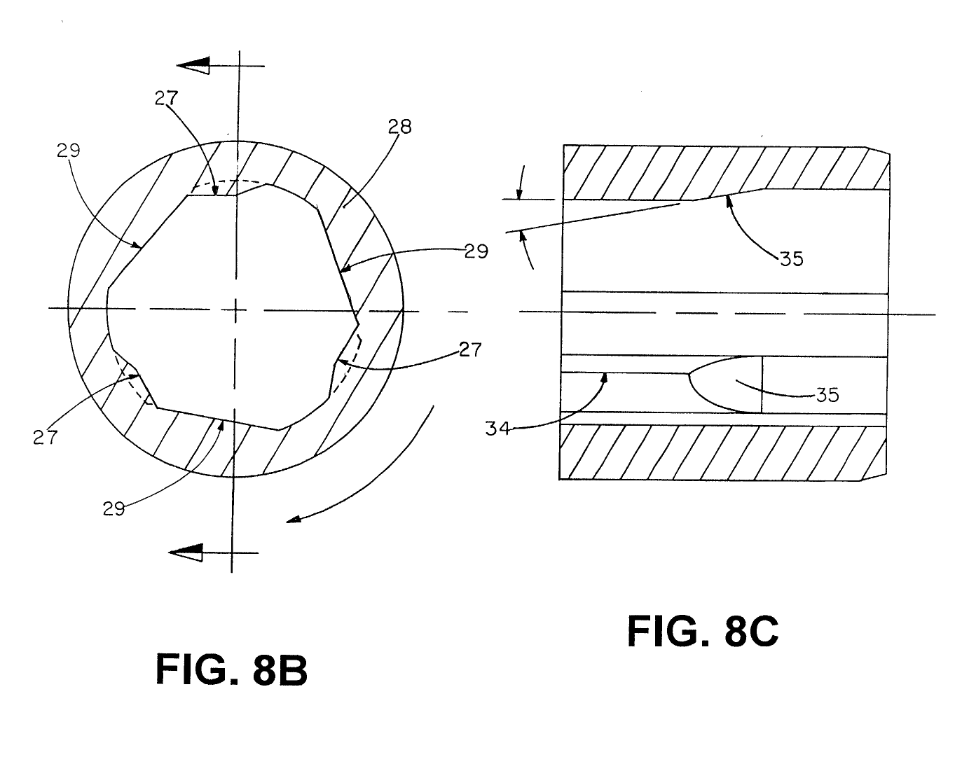

FIGS. 8A and 8B illustrate the basic design of the socket tool that has three smooth faces with no deviations and three shaped such that each forward portion has an axial driving ridge 34 and each rearward portion has a taper 35.

To tighten the joint, the tool with a socket 28 (FIGS. 4 to 8A) engages the nut to transmit torque through an array of internal surfaces, working in tandem pairs, each pair dedicated to a nut crest. As each lead surface 27 presses against each nut crest 18 simultaneously, torque rises with resistance from the increasingly reluctant nut that rotates progressively slower. Unaffected by the rising torque, the socket tool 28 begins to burnish the nut crests 18 and torque rises to a maximum when the driving surfaces 27 establish some correspondence with the nut apices 23 (FIG. 5). The three leading surfaces are planar shaped with a forward directional change, and their cradled support discourages distortion of the hoop characteristic of the nut under torque. They elevate tangential torque and redistribute material. Dissipation of this transported material 30 registers a decrease of torque and the nut ceases to rotate, but torque rises again as the smooth trailing flats 29 (FIG. 6) engage residual crest material. The smooth face of the trailing flats 29 assure, that as torque rises again desirably to approximate or exceed that of the previous tightening level, the tangential component will remain diminished so that the nut will not resume rotation while being locked. These trailing flats 29 are separated from the leading surfaces 27 by an angle of 40 to 50 degrees and they compress the nut circumference to a smaller diameter than that which the leading surfaces accomplish. Inspection of locking quality can be adjudicated by deciding a range of diameter values for the swaged nut barrel portion 31.

Compressive swaging is not the only force acting on the nut threads. When swaging begins a tension force, due to tightening, already exists on the fastener 15. This force wants to pull the nut threads axially forward but they resist with an equal and opposite force. Compressive swaging upsets this equilibrium condition so that the relevant thread portions 13 flatten and deform laterally, relieving tension as they bunch together to jam the cross path of the contrary pin flute. To complete the swaging process, the socket tool 28 will have rotated about 135 degrees relative to the nut (FIG. 7) surface and the rounded nut diameter 31 is larger than that of a circle that can be inscribed to touch the intercrest bottoms of the pre-installed nut. Extraction of the tool 28, when idly rotating, may require a small axial pull to overcome friction. Thus with the swaging process completed, the nut will not loosen under vibrational forces because the bunched threads 13 that choke the winding path of the pin flute 10 interfere with the pin threads 11. After swaging, nut and pin threads 11 are no longer confluent (see FIG. 3A).

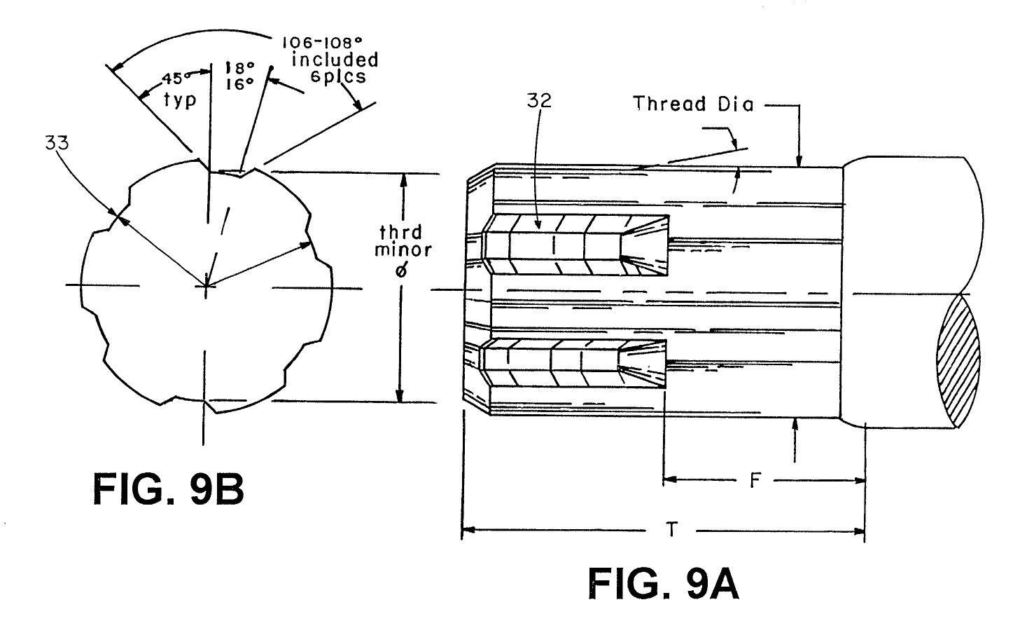

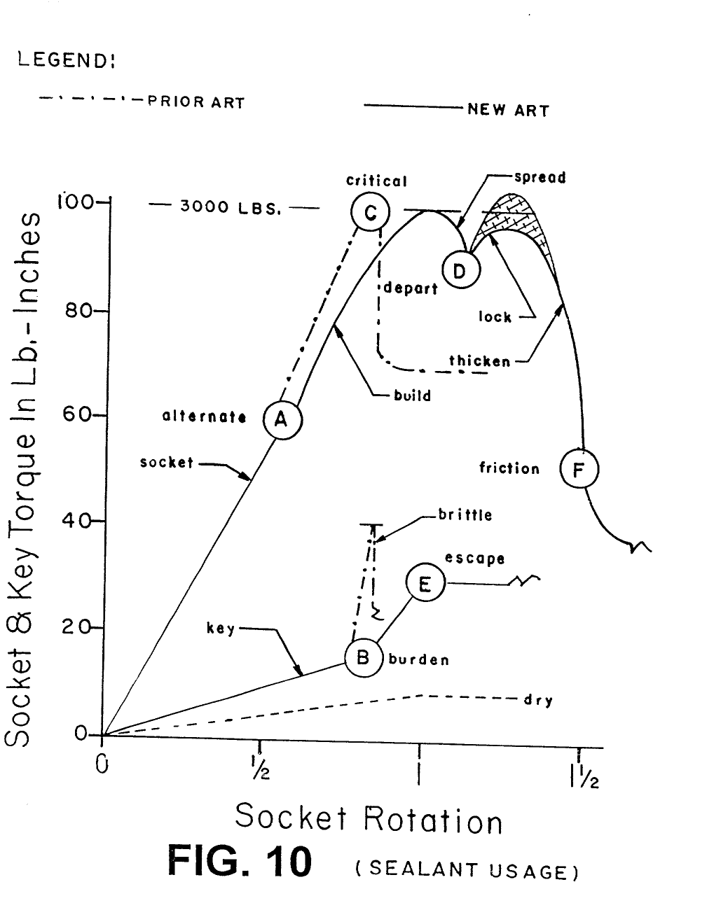

To a lesser degree, this type of thread interference that is installation generated may be obtained with pin flutes that are axial 32 (FIG. 9A), provided that such flutes have a bottom 33 that is convex and coincides with the minor diameter of the threads 12 over an arc of 15-20 degrees (see FIG. 9). These axial flutes 32, like the spiral flutes 10, do not extend into the pin threads 11 that are functionally forward of the swagable rear nut barrel. Other flute forms, that circle the pin, are also within the scope of this invention. For example, a flute may be circular, or it may be helical and advance in the same direction as the pin threads. Nevertheless, whatever the inventive form, FIG. 10 provides a pictographic comparison for both prior and new art fasteners of the NF#0.250-28 size in a sealant environment.

The plots for fasteners of each art indicate that the nut needs to rotate just less than one full, compressive turn under maximum torque of about 100 lb.-inches to develop a load of about 3,000 lbs. on a workpiece. Both graphs plotted for Socket Torque Versus Rotation share a steep linear path up to Zone (A) with the prior art continuing its linear rise to the critical point, Zone (C), because both socket and nut continue to rotate at the same rate. The longitudinal nut lobes then suffer crushing at Zone (C) and yield for the first time elastically but insufficient to trigger a decline of applied torque. Still driven by 100 lb.-inches of torque, the collapsing nut rotatively binds its threads to the pin threads and captivates the pin. Pin captivation produces the burden at Zone (B) on the hex key graph that shows a surge for restraint beyond the key's capacity. Thus the key fractures, or may twist like a corkscrew.

In the presence of a lubricant sealant, this sinister burden that ruins the hex key reveals itself and can no longer remain obscure, because friction between the fastener head 14 and the workpiece 26 is too greatly diminished to provide latent resistance when the nut grabs the pin. The hex key then fractures or twisted because it can provide a maximum of only 40 lb.-inches of counter-torque force. In general application, service demand would be less than 10 lb.-inches as the phantom graph indicates and the hex key would retain up to 75 percent of its torque capacity as reserve.

Returning to Zone (A) and with reference to FIGS. 4 and 7, the alternative path for the new art fastener indicates that the socket 28 is rotating faster than the nut (FIG. 5). The path is curved and says that the shaped driving surfaces 27 of the socket tool are burnishing a portion of nut crest 18 material to build up longitudinal driving ribs 30 that enhance superiority of tangential torque over its radial torque component. This rib building process ends with elevated torque at about 100 lb.-inches and the loop in the graph shows that the nut crest apices 23 are burnished. The nut now ceases to rotate and correspondingly on the counter-torque graph, Zone (E) indicates that the hex key has escaped failure with about 25 percent of its capacity remaining. As the torque curve declines thereafter, to Zone (D), the stack of material 30 transported from the fore side of the nut apices 23 is now spread out on the aft side and the driving surfaces 27 of the socket, now losing torque, prepare to depart from contact with the nut. Just then, however, torque rises again as the smooth swaging elements 29 of the socket 28 contact residual nut crest material (FIG. 6) and the graph shows a second peak that approximates or may exceed the first. Now comfortably at rest, the nut is under no pressure to resume rotation because the second peak torque crushes selective nut thread portions with the ratio of a radial torque to tangential torque that is greater than previously applied. Insufficient torque will not induce locking of the threads, therefore the applied torque recovery should not be too different from the former (see shaded areas of the graph of FIG. 10).

Descent of the graph beyond the second peak indicates that the swaging elements 29 are thickening the inter-crest nut regions with transported material, and at Zone (F) friction remains as the only dynamic force acting on the system (FIG. 7). Continued rotation of the socket would now be unproductive because of the possibility of generating heat, especially if the tool is pneumatically activated. It is therefore left to the technician to encourage disengagement by exerting a small axial pull on the rotating tool 28 to overcome friction.

For long tool life, carbide is the preferred material and its cavity can be easily shaped by Wire EDM (Electrical Discharge Machining) technology. As an auxiliary to the installation process, the nut may be coated with molybdenum disulphide to prevent galling.

Having thus disclosed preferred embodiments of the invention, it being understood that variations not expressly disclosed herein are contemplated, and that the scope hereof is limited only by the appended claims and their equivalents;

What is claimed is:

1. A self-locking fastening system for securing a plurality of abutting surfaces; the system comprising:
an elongated pin extendable through aligned holes in said surfaces and having threads at a first end and a tapered head at a second end, said first end also having at least one helical flute advancing oppositely to said threads to interrupt at least some of said threads;
a swagable nut having internally disposed threads configured for engaging said pin threads for trapping said abutting surfaces between said tapered head and said nut, said nut having two distinct contiguous portions, one such portion being a larger cylindrical forward portion and the other such portion being a smaller equilateral rearward portion; and
a socket tool having a socket for radially engaging said smaller equilateral rearward portion of said nut for threadably tightening said nut against said surfaces and then swaging said nut into a locked configuration on said pin.

2. The fastening system recited in claim 1 wherein said socket tool comprises an adapter end and a socket end, said socket end having said socket for engaging said nut, said adapter end having standard surfaces for application of torque to said socket tool.

3. The fastening system recited in claim 1 wherein said smaller equilateral rearward portion of said nut comprises three convex planes intersecting at three equally spaced crest apices, each such apex forming an axial line along said rearward portion.

4. The fastening system recited in claim 3, said socket having three shaped cavity surfaces alternately interposed between three planar cavity surfaces.

5. The fastening system recited in claim 4 wherein said socket initially engages said nut rearward portion so that each of said shaped cavity surfaces engages a respective portion of said nut at a location displaced from a respective apex for applying rotational torque to said nut.

6. The fastening system recited in claim 5 wherein upon overcoming increasing resistance by said nut, the elevated torque delivered by said socket tool causes the shaped cavity surfaces to initiate tangential deformation of said apices.

7. A self-locking fastening system for securing a plurality of abutting surfaces; the system comprising:
an elongated pin extendable through aligned holes in said surfaces and having a tapered head at one end and a threaded shaft at another end;
a nut configured for engaging said threaded shaft and having a torquing head having a plurality of convex planes intersecting the equilaterally spaced apices; and
a socket tool having a nut-engaging cavity having shaped surfaces arrayed around a center and alternately interposed between planar cavity surfaces for rotating and tightening said nut and then swaging said nut to deform said apices.

8. The fastening system recited in claim 7 wherein said socket tool comprises an adapter end and a socket end, said socket end having said socket for engaging said nut, said adapter end having standard surfaces for application of torque to said socket tool.

9. The fastening system recited in claim 7 wherein said nut comprises two distinct contiguous portions, one such portion being a larger cylindrical forward portion and the other such portion being a smaller equilateral rearward portion.

10. The fastening system recited in claim 9 wherein said smaller equilateral rearward portion of said nut comprises three convex planes intersecting at three equally spaced crest apices, each such apex forming an axial line along said rearward portion.

11. The fastening system recited in claim 10, said socket having thee shaped cavity surfaces alternately interposed between three planar cavity surfaces.

12. The fastening system recited in claim 11 wherein said socket initially engages said nut rearward portion so that each of said shaped cavity surfaces engages a respective portion of said nut at a location displaced from a respective apex for applying rotational torque to said nut.

13. The fastener system recited in claim 12 wherein said shaped surfaces terminate internally at a rearward taper, said taper providing relief for molding an enlarging conical form on the rearmost tip of the nut to trap the socket temporarily to the nut.

14. The fastening system recited in claim 13 wherein upon completion of rotation of said nut by said socket tool, said shaped cavity surfaces continue to deform tangentially material capped by said apices with further applied torque.

15. The fastening system recited in claim 14 wherein during the waning phase of the tightening process the three smooth socket faces pick up the task to work residual nut crest material either tangentially or radially.

16. The fastening system recited in claim 7, said threaded shaft of said pin comprising at least one helical flute advancing oppositely to the threads to interrupt at least some of said threads.

17. The fastening system recited in claim 16 wherein said radially displaced nut material causes the underlying nut thread portions to collapse and expand axially to stuff the void in said pin flute thereby to lock the nut and the pin together.

18. The fastening system recited in claim 7, said threaded shaft of said pin comprising at least one axial flute interrupting at least some of said threads.

19. The fastener system recited in claim 18 wherein the pin flutes are axial and in an array on the threaded end of the pin thereby removing portions from some of the threads to the depth of their minor diameter and establishing thread-free zones that are 15-20 degrees wide with the common center of their arcs residing on a central axis of the nut.
